(19) United States
(12) Patent Application Publication
(10) Pub. No.: US 2011/0260430 A1
(43) Pub. Date: Oct. 27, 2011

(54) Utility trailer with extendable cargo bed

(75) Inventor: Vladan Markovich, Aurora (CA)

(73) Assignee: SNOWBEAR LIMITED

(21) Appl. No.: 12/662,654

(22) Filed: Apr. 27, 2010

(51) Int. Cl. B60P 3/00; B62D 33/08

(52) U.S. Cl. 280/656; 296/26.11

(57) ABSTRACT

The present invention relates to the field of utility trailers, in particular, utility trailers with extendable cargo beds. The utility trailer includes an extendable cargo bed supported on wheels for rolling motion on the ground. The extendable cargo bed has a support frame and a floor carried by the support frame. The floor defined at least partially the footprint of the cargo bed. A gate is connected to one of the floor or the support frame. The gate includes a first gate portion disposed adjacent the support frame and a second gate portion movable relative to the first gate portion. The gate is deployable in first, second and third positions. When deployed in the first position, the gate extends upwardly from the floor. When deployed in the second position, the gate is substantially flush with the floor and the footprint of the cargo bed is extended by the first and second gate portions. When deployed in the third position, the first gate portion is substantially flush with the floor, the footprint of the cargo bed is extended by the first gate portion, and the second gate portion is oriented upwardly. The provision of the movable second gate portion allows the cargo bed to be deployed in a plurality of configurations quickly and easily, thereby enhancing the versatility of the utility trailer.

### FIELD OF THE INVENTION

The present invention relates to the field of utility trailers, in particular, utility trailers with extendable cargo beds.

### BACKGROUND OF THE INVENTION

Utility trailers have cargo beds on which may be placed lading for transport. It is the case for many utility trailers that the size (i.e. footprint) of their respective cargo beds is fixed. Provided the nature of the cargo to be hauled does not exceed the available footprint of the cargo bed, utility trailers with fixed-size cargo beds tend to perform adequately. However, such utility trailers tend to be ill-equipped to handle cargo which exceeds the available footprint of the cargo bed. In some such circumstances, it may be necessary to have a portion of the cargo extend beyond the cargo bed footprint, unsupported. From a road safety perspective, this tends to be less than ideal. In other circumstances, it may not be possible to haul the over-sized cargo using such utility trailers. The inability to re-configure the cargo bed as needed to extend its available footprint tends to limit the versatility of such utility trailers.

To address the afore-mentioned drawbacks, some utility trailers have been designed with extendable cargo beds. One such utility trailer is shown and described in U.S. Pat. No. 6,378,893 of Jager, which is owned by Snowbear Limited of Guelph, Ontario, Canada, also the assignee of the subject application. U.S. Pat. No. 6,378,893 (the disclosure of which is hereby incorporated by reference) describes front and rear, manually removable, gates for a trailer. The gates can be coupled to the trailer either in a wall-forming configuration or a bed-extending configuration. When in their respective wall-forming configurations, the gates stand substantially upright from the trailer bed. When in their respective bed-extending configurations, the gates lie generally in the same plane as the trailer bed. The front and rear gates are coupled to the trailer bed by a plug-in-socket sliding arrangement which for each gate consists of, on the one hand, a pair of spaced apart, angled female sockets formed in the support frame and on the other hand, a pair of male connector members projecting at an angle from the bottom of each gate. The female socket members are configured to slidingly receive therein the male connector members.

Utility trailers constructed in accordance with U.S. Pat. No. 6,378,893 have been well-received in the marketplace as they provide the user some flexibility to configure the trailer bed as required to suit a particular load carrying application. More specifically, with such utility trailers, the user can choose between four trailer bed configurations—one most compact configuration (wherein both the front and rear gates are in their wall-forming configurations), two partially extended configurations (wherein one of the front gate or the rear gate is in its wall-forming configuration while the other of the gates is in its bed-extending configuration) and one fully extended configuration (wherein both the front and rear gates are in their respective bed-extending configurations). However, when the front and/or rear gates is in its bed-extending configuration, there is no wall or guard rail to prevent the lading from sliding off one or both ends of the utility trailer.

It would be desirable to have a utility trailer which could offer to the user even more cargo bed configurations and allow the user the freedom to configure the cargo bed as required, with the option of deploying walls or guard rails in at least some of the partially extended configurations or in the fully extended configuration.

### SUMMARY OF THE INVENTION

According to a broad aspect of an embodiment of the present invention, there is provided an extendable cargo bed including a support frame and a floor carried by the support frame. The floor defines at least partially the footprint of the cargo bed. A gate connects to one of the floor or the support frame. The gate includes a first gate portion disposed adjacent the support frame and a second gate portion movable relative to the first gate portion. The gate is deployable in first, second and third positions. When deployed in the first position, the gate extends upwardly from the floor. When deployed in the second position, the gate is substantially flush with the floor and the footprint of the cargo bed is extended by the first and second gate portions. When deployed in the third position, the first gate portion is substantially flush with the floor, the footprint of the cargo bed is extended by the first gate portion, and the second gate portion is oriented upwardly.

In another feature, the gate is releasably attached to the support frame. In an additional feature, a portion of the gate slidingly engages a portion of the support frame to attach the gate to the support frame.

In an alternate feature, the gate is hingedly connected to the support frame and the gate may be pivoted between the first and second positions.

In yet another feature, the gate is a first gate and the extendable cargo bed has a second gate connected to one of the floor or the support frame. The first bed is hingedly connected to the support frame and the second bed is releasably attached to the support frame. In a further feature, the second gate includes a third gate portion disposed adjacent the support frame and a fourth gate portion movable relative to the third gate portion. The second gate is deployable in fourth, fifth and sixth positions. When deployed in the fourth position, the second gate extends upwardly from the floor. When deployed in the fifth position, the second gate is substantially flush with the floor and the footprint of the cargo bed is extended by the third and fourth gate portions. When deployed in the sixth position, the third gate portion is substantially flush with the floor, the footprint of the cargo bed is extended by the third gate portion, and the fourth gate portion is oriented upwardly.

In still another feature, the footprint of the cargo bed is most compact when the first gate is deployed in the first position and the second gate is deployed in the fourth position. In an additional feature, the footprint of the cargo bed is fully extended when the first gate is deployed in the second position and the second gate is deployed in the fifth position.

In a further feature, the footprint of the cargo bed is at least partially extended when the first gate is deployed in one of the first position, the second position and the third position and the second gate is deployed in one of the fifth position and the sixth position. Additionally, the footprint of the cargo bed is at least partially extended when the second gate is deployed in one of the fourth position, the fifth position and the sixth position and the first gate is deployed in one of the second position and the third position.

In yet another feature, the gate includes a frame having a back, and first and second spaced apart arms depending from the back. Each of the first and second gate portions are mounted to the frame between the first and second arms. The second gate portion is pivotally connected to the frame. More specifically, the second gate portion is pivotally connected to the first and second arms at locations adjacent the back.

In still another feature, the second gate portion is pivotable between fourth and fifth positions. When in the fourth position, the second gate portion is oriented upwardly. When in the fifth position, the second gate portion has a substantially horizontal orientation.

Additionally, the extendable cargo bed includes a first stop operable to prevent movement of the second gate portion beyond the fourth portion and a second stop operable to prevent movement of the second gate portion beyond the fifth position.

According to another broad aspect of an embodiment of the present invention, there is provided a utility trailer having an extendable cargo bed supported on wheels for rolling motion on the ground. The extendable cargo bed includes a support frame and a floor carried by the support frame. The floor defines at least partially the footprint of the cargo bed. A gate connects to one of the floor or the support frame. The gate includes a first gate portion disposed adjacent the support frame and a second gate portion movable relative to the first gate portion. The gate is deployable in first, second and third positions. When deployed in the first position, the gate extends upwardly from the floor. When deployed in the second position, the gate is substantially flush with the floor and the footprint of the cargo bed is extended by the first and second gate portions. When deployed in the third position, the first gate portion is substantially flush with the floor, the footprint of the cargo bed is extended by the first gate portion, and the second gate portion is oriented upwardly.

In one feature, the gate is hingedly connected to the support frame and may be pivoted between the first and second positions.

In another feature, the support frame includes front and rear ends, and the utility further includes a tow bar extending from the front end of the support frame. When the gate is deployed in one of the second and the third positions, the gate is at least partially supported by the tow bar.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a front right perspective view of a utility trailer in accordance with an embodiment of the invention showing the cargo bed in its most compact configuration with the front and rear gates shown in their respective fully raised positions;

FIG. 2a is a bottom plan view of the utility trailer illustrated in FIG. 1;

FIG. 2b is bottom left, isolated perspective view of the support frame of the utility trailer illustrated in FIG. 2, with the front and rear gates, the wheel axle, the wheels and the suspension system omitted for the purposes of clarity;

FIG. 3 is a view of the utility trailer similar to that illustrated in FIG. 1 showing the front gate and side panels exploded from the remainder of the utility trailer;

FIG. 4a is an enlarged, isolated, perspective view of the left side pin-and-socket arrangement of the front gate illustrated in FIG. 3;

FIG. 4b is a view of the left side pin-and-socket arrangement illustrated in FIG. 4a showing the pin received within the socket;

FIG. 4c is a cross-sectional view of the left side pin-and-socket arrangement illustrated in FIG. 4b;

FIG. 5 is a side elevation view of the utility trailer illustrated in FIG. 1 showing the cargo bed being configured to have a partially extended configuration with the front gate of the utility trailer being moved from its fully raised position to its fully lowered position;

FIG. 6 is front right perspective view of the utility trailer shown in FIG. 4;

FIG. 7 is view of the utility trailer similar to that illustrated in FIG. 6 showing the second movable panel of the front gate in its raised position;

FIG. 8 is an enlarged cross-sectional view of the second movable panel of the front gate illustrated in FIG. 7 showing the second movable panel being moved from its lowered position to its raised position;

FIG. 9 is a view of the utility trailer similar to that illustrated in FIG. 1 showing the rear gate exploded from the utility trailer;

FIG. 10a is an enlarged, isolated, perspective view of the right side stake member-and-socket arrangement of the rear gate illustrated in FIG. 9;

FIG. 10b is a view of the right side stake-pocket arrangement illustrated in FIG. 10a showing the stake member received within the socket;

FIG. 10c is a cross-sectional view of the right side stake member-and-socket arrangement illustrated in FIG. 10b;

FIG. 11 is a rear left, perspective view of the utility trailer illustrated in FIG. 1 showing the cargo bed in another, partially extended configuration with the rear gate of the utility trailer its fully lowered position;

FIG. 12a is an enlarged, isolated, perspective view of the left side stake-pocket arrangement of the rear gate illustrated in FIG. 11, with the stake member shown exploded from the socket;

FIG. 12b is a view of the left side stake member-and-socket arrangement illustrated in FIG. 11;

FIG. 12c is a cross-sectional view of the left side stake member-and-socket arrangement illustrated in FIG. 11;

FIG. 13 is a view of the utility trailer similar to that shown in FIG. 1 showing the cargo bed in yet another, partially extended configuration with the first panel of the rear gate in its lowered position and the second movable panel of the rear gate in its raised position;

FIG. 14 is rear left perspective view of the utility trailer illustrated in FIG. 1 showing the cargo bed in yet another, partially extended configuration with the first movable panel of each of the gates being shown in its respective lowered position and the second movable panel of each of the gates being shown in its respective raised position;

FIG. 15 is rear left perspective view of the utility trailer illustrated in FIG. 1 showing the cargo bed in yet another, partially extended configuration with the first movable panel of each of the gates being shown in its respective lowered position, the second movable panel of the rear gate being shown in its raised position and the second movable panel of the front gate being shown in its lowered position;

FIG. 16 is rear left perspective view of the utility trailer illustrated in FIG. 1 showing the cargo bed in yet another, partially extended configuration with the first movable panel of each of the gates being shown in its respective lowered position, the second movable panel of the front gate being shown in its raised position and the second movable panel of the rear gate being shown in its lowered position;

FIG. 17 is another view of the utility trailer similar to that illustrated in FIG. 1 showing the cargo bed in a fully extended configuration and the front and rear gates in their fully lowered positions;

FIG. 18 is a rear left perspective view of a utility trailer in accordance with another embodiment of the present invention;

FIG. 19 is another rear left perspective view of the utility trailer illustrated in FIG. 18 showing the front gate of the utility trailer in its fully lowered position and the rear gate in its declined (in-use) position); and

FIG. 20 is a front right perspective view of the utility trailer illustrated in FIG. 18 showing the second movable panel of the front gate in its raised position and the rear gate in its raised position.

### DETAILED DESCRIPTION OF EMBODIMENTS OF THE INVENTION

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

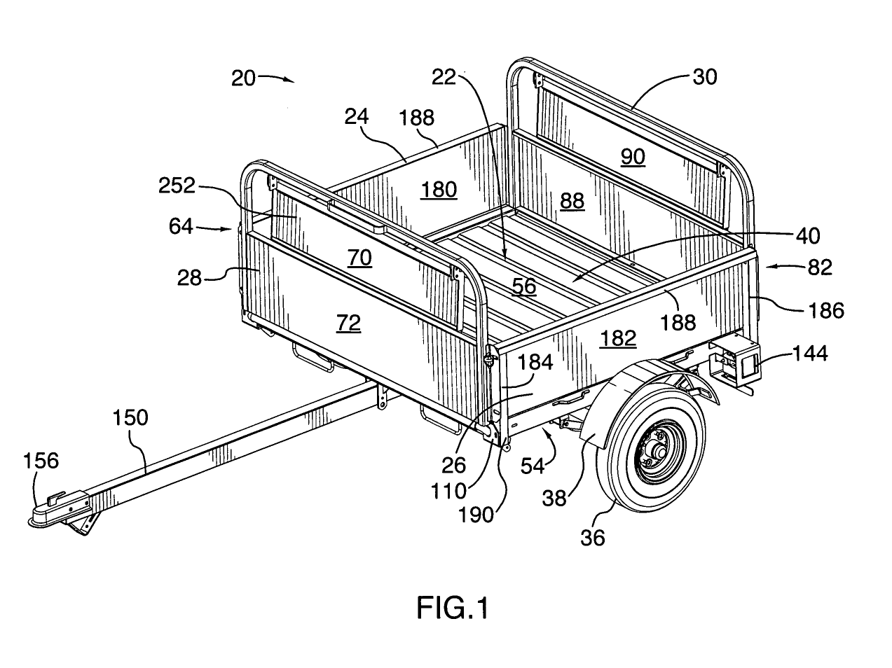

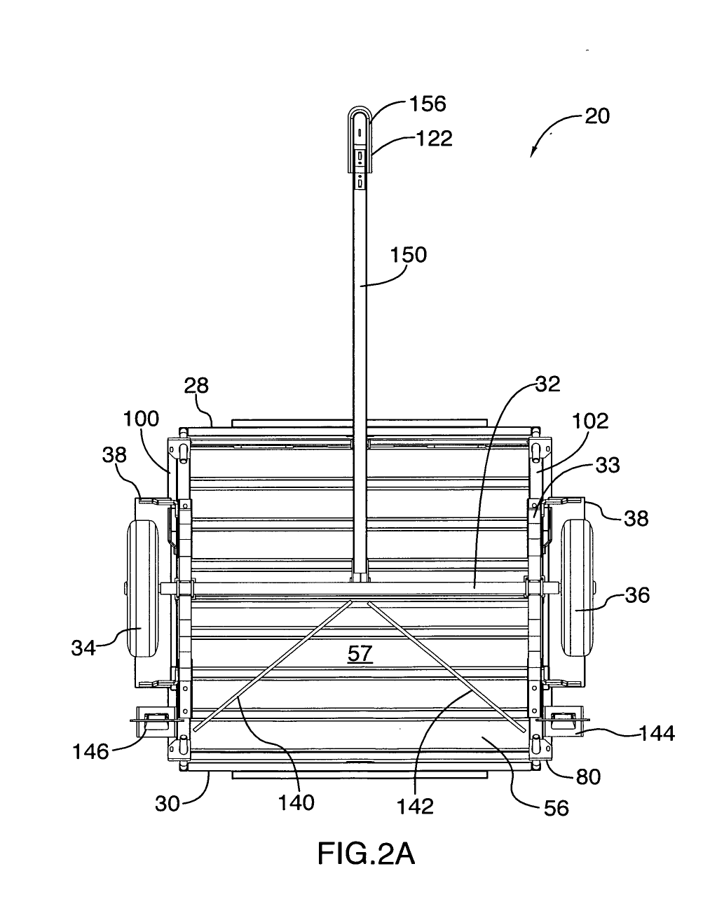

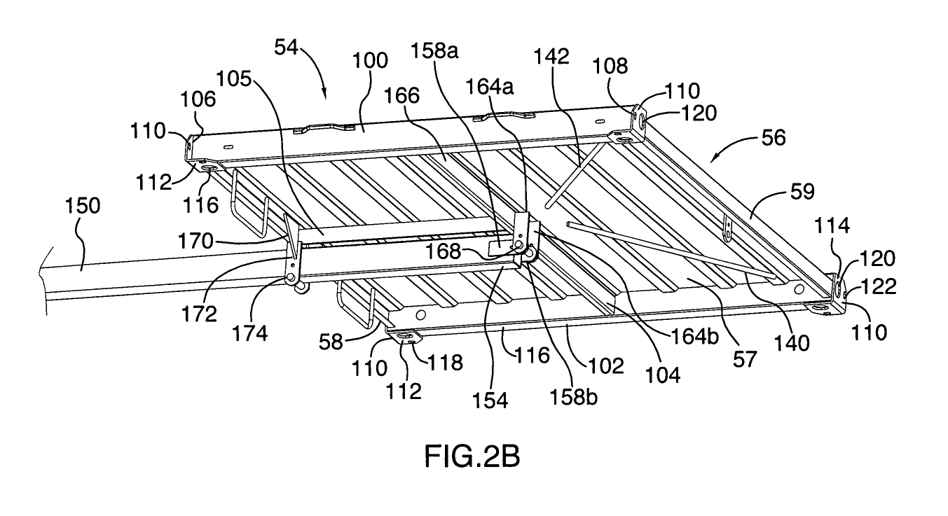

Referring to FIGS. 1 to 6, there is shown a utility trailer, designated generally with reference numeral 20. The trailer 20 is designed to be hitched to the rear of a motor vehicle (not shown) and towed. The trailer 20 has a cargo bed 22 whose boundaries are defined by a pair of spaced apart side panels 24 and 26, and front and rear gates 28 and 30. The cargo bed 22 is supported on a single axle 32 via a multiple leaf spring-type suspension system 33 (visible in FIG. 2). The single axle 32 carries a pair of spaced apart wheels 34 and 36. Each wheel 34, 36 is provided with a protective wheel cover 38 that depends from the cargo bed 22. In an alternative embodiment, the trailer could be configured as a dual-axle trailer.

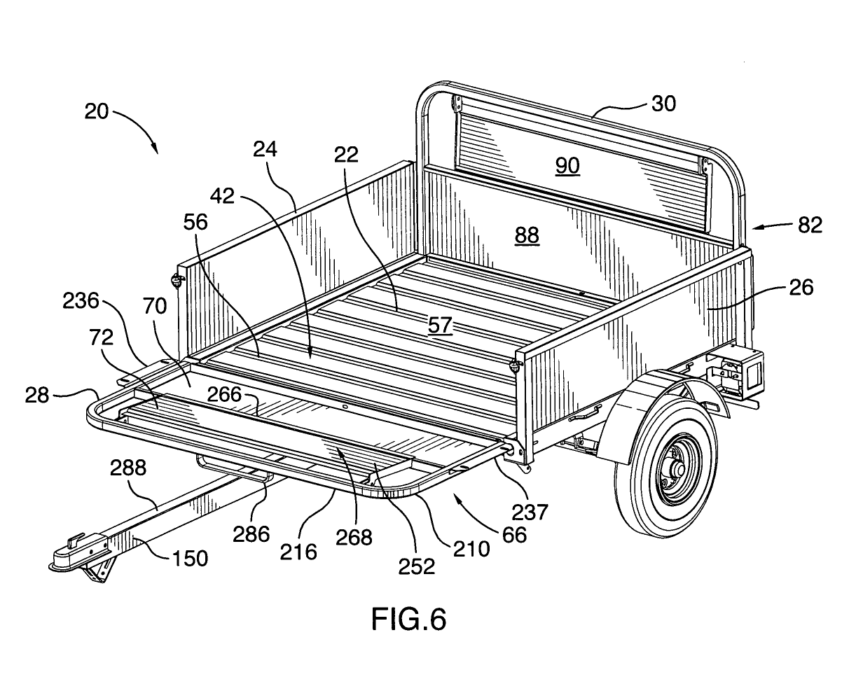

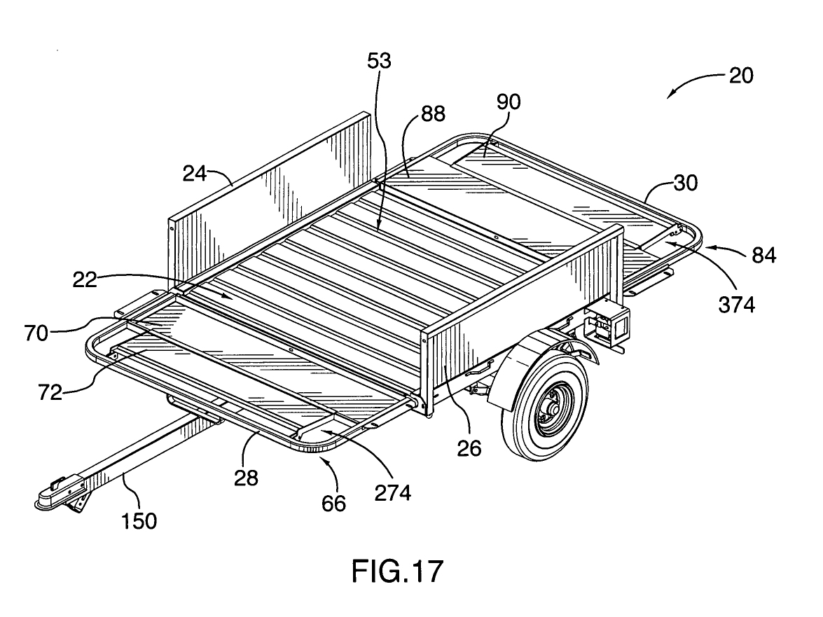

As will be explained in greater detail below, the cargo bed 22 can be deployed in nine different configurations, including a most compact configuration 40 (shown in FIG. 1), a number of partially extended configurations 42, 44, 46, 48, 50, 51 and 52 (shown in FIGS. 6, 7, 11, 13, 14, 15 and 16 respectively) and a fully extended configuration 53 (shown in FIG. 17). When in its most compact configuration 40, the cargo bed 22 has a generally square shape and is defined by a support frame 54 and a floor 56 mounted atop the support frame 54 upon which cargo may be placed. When in its partially extended configurations 42, 44, 46, 48, 50, 51 and 52 or fully extended configuration 53, the cargo bed 22 has a generally rectangular footprint with one or more portions of the front gate 28 and/or the rear gate 30 further forming part (i.e. one or more extensions) of the cargo bed 22.

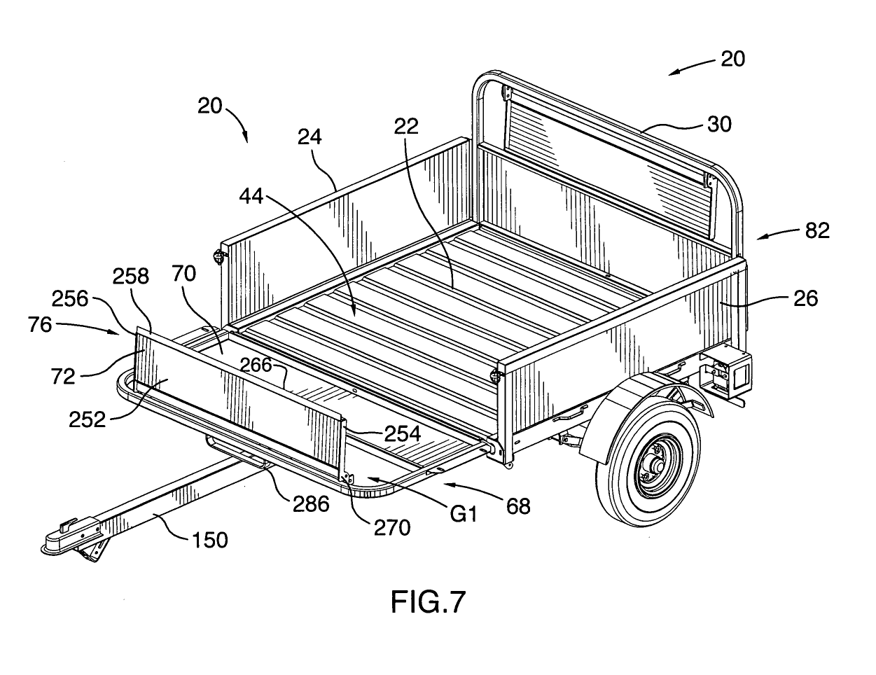

In this embodiment, the front gate 28 is pivotally connected to the support frame 54 at the front end thereof. The front gate 28 is movable between a first, fully raised position 64 (shown in FIG. 1) and a second, fully lowered position 66 (shown in FIG. 6). When the front gate 28 is in the first, fully raised position 64, the gate 28 is in a substantially upright position relative to the floor 56 and forms a wall which restricts access to the cargo bed 22 from the front end. When in the second, fully lowered position 66, the front gate 28 permits access to the cargo bed 22 to facilitate loading. The front gate 28 may also be moved to a third position 68 (shown in FIG. 7) whereat a first, fixed, gate panel member 70 remains in a lowered position and a second, movable, gate panel member 72 is in a raised (or upright) position 76. As will be explained in greater detail below, when the front gate 28 is in the second position 66, the first and second gate panel members 70 and 72 serve to extend the cargo bed 22 longitudinally (or lengthwise) and when the front gate 28 is in the third position 68, only the first gate panel member 70 operates to longitudinally extend the cargo bed 22 in the forward direction.

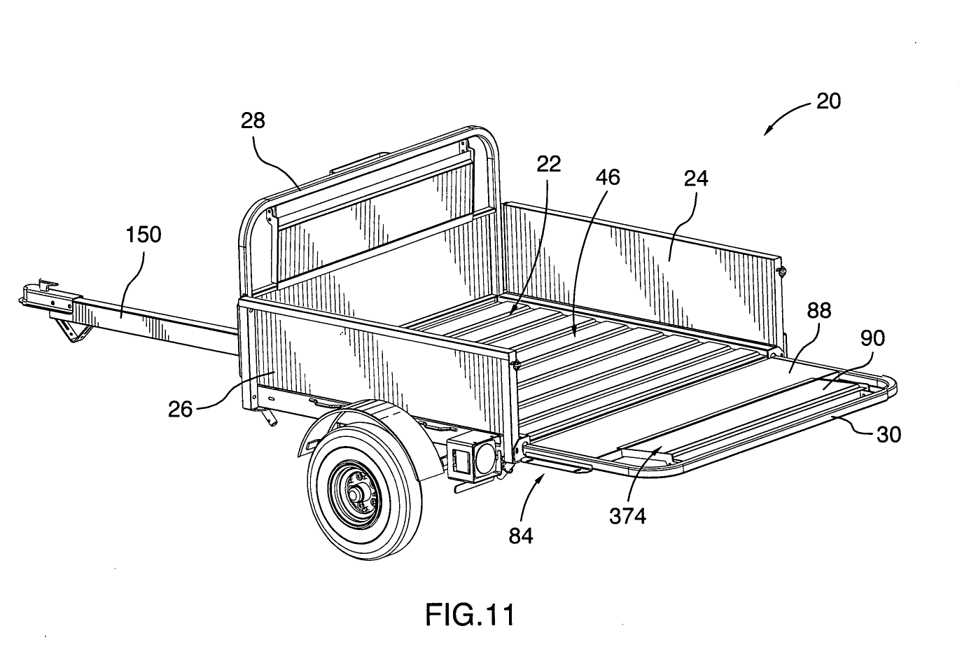

The rear gate 30 is removably mounted to the support frame 54 at the rear end thereof The rear gate 30 can be deployed in a first, fully raised position 82 (shown in FIG. 1) and a second, fully lowered position 84 (shown in FIG. 11). When the rear gate 30 is in the first, fully raised position 82, the gate 30 is in a substantially upright position relative to the floor 56 and forms a wall which restricts access to the cargo bed 22 from the rear end. When in the second, fully lowered position 84, the rear gate 30 permits access to the cargo bed 22 to facilitate loading. The rear gate 30 may also be moved to a third position 86 (shown in FIG. 7) whereat a first gate panel member 88 is in a lowered position and a second gate panel member 90 is in a raised (or upright) position 94. When the rear gate 30 is in the second position 84, the first and second gate panel members 88 and 90 serve to extend longitudinally (or lengthwise) the cargo bed 22 and when the rear gate 30 is in the third position 68, only the first gate panel member 88 operates to longitudinally extend the cargo bed 22 in the rearward direction.

Referring to FIGS. 2a and 2b, in this embodiment, the floor 56 takes the form of a single, solid panel 57 of corrugated steel. The front and rear end portions 58 and 59 of the panel 57 are bent downwardly to form additional transverse support members for the support frame 54. The support frame 54 includes a generally H-shaped framework defined by a pair of spaced apart, first and second longitudinal members 100 and 102, a cross-member 104 extending between and joining the first and second longitudinal members 100 and 102 and a longitudinal stringer 105. The cross-member 104 is disposed roughly midway between the front and rear end portions 58 and 59 of the panel 57. The longitudinal stringer 105 runs parallel to the first and second longitudinal members 100 and 102 and is welded at one end to cross-member 104 at its midspan and at the opposite end to the front end portion 58 of panel 57.

Each longitudinal member 100, 102 is fabricated from a section of generally rectangular hollow structural steel (HSS), and has a front end 106 and a rear end 108. Capping each end 106, 108 of longitudinal members 100 and 102 is an angle member 110. Each angle member 110 includes a first leg portion 112 welded to the bottom face 115 of each longitudinal member 100, 102 in a horizontal orientation and a second leg portion 114 welded to the end 106, 108 (as the case may be) of each longitudinal member 100, 102 in a vertical orientation. Each first leg portion 112 has a relatively large, substantially oval bore 116 and a relatively, smaller aperture 118. When the angle member 110 is fixed to the longitudinal member 100, 102 (as the case may be), the oval bore 116 is substantially aligned with the hollow of longitudinal member 100, 102 so as to provide access thereto, and the smaller aperture is disposed outwardly of the lateral face 118 of the longitudinal member 100, 102. Similarly, the second leg portion 114 is also provided with a relatively large, substantially oval bore 120 and a relatively, smaller aperture 122. When the angle member 110 is fixed to the longitudinal member 100, 102 (as the case may be), the oval bore 120 is substantially aligned with an aperture (not visible) defined in the bottom face 116 of longitudinal member 100, 102 so as to provide access thereto, and the smaller aperture 122 is disposed outwardly of the lateral face 118 of the longitudinal member 100, 102.

The angle members 110 together with the front ends 106 of the longitudinal members 100 and 102 define front sockets 132 and 133 that are configured to receive portions of connector or hinge pins 134 and 135. The hinge pins 134 and 135 serve to pivotally attach the front gate 28 to the support frame 54. Similarly, the angle members 110 in cooperation with the rear ends 108 of longitudinal members 100 and 102 define rear sockets 136 and 137 that are configured to receive a portion of stake members 138 and 139 for attaching the rear gate 30 to support frame 54. Each of the sockets 132, 133, 136 and 137 has a socket axis S oriented on a decline relative to a horizontal plane H defined by the cargo bed 22. Preferably, for each socket 132, 133, 136, 137 the angle of decline θ (defined between the socket axis S and the horizontal plane H) is 45 degrees. While a preferred structure of the sockets 132, 133, 136 and 137 has been described above, it will be appreciated that, in alternative embodiments, the front and rear sockets could be configured differently. For instance, in another embodiment, the front and rear sockets could be made as described and shown in U.S. Pat. No. 6,378,893.

Mounted to the panel 57 in a mirror-image arrangement is a pair of spaced apart, first and second wire tubes 140 and 142. The first wire tube 140 runs diagonally from adjacent the rear end 108 of the first longitudinal member 100 toward the midspan of the cross-member 104. Similarly, the second wire tube 142 runs diagonally from adjacent the rear end 108 of the second longitudinal member 102 toward the midspan of the cross-member 104. Each wire tube 140, 142 is intended to receive therethrough electrical wires running from a signal light assembly 144, 146 (as the case may be) carried on the lateral face 118 of the longitudinal member 102, 104 (as the case may be) adjacent the rear end 108 thereof.

An elongate tongue (or tow bar) 150 centrally disposed between the first and second longitudinal members 100 and 102, projects from the front end of the support frame 54. The tongue 150 includes a first end 152 and an opposed second end 154 connected to the cross-member 104. At its first end 122, the tongue 150 carries a coupler 156 for connecting the trailer 20 to the hitch (not shown) of a motor vehicle. Projecting longitudinally from, and welded to, the second end 154 is a first pair of mounting plates 158a and 158b. Each mounting plate 158a, 158b has an aperture defined therein which is alignable with a corresponding aperture formed in a second pair of mounting plates 164a and 164b. The mounting plates 164a and 164b are oriented downwardly and are fixed along their respective edges to the rear face 166 of the cross-member 104. A connector pin 168 received with the aligned apertures connects the mounting plates 158a and 158b to the mounting plates 164a and 164b. The tongue 150 is also connected to the front end portion 58 of the panel 57 at a location intermediate its first and second ends 152 and 154. A pair of triangular gusset plates 170 is welded to the underside of the panel 57 and depends downwardly therefrom. Welded to each gusset plate 170 is a mounting plate 172. The mounting plates 172 are spaced apart to accommodate the tongue 150 therebetween. The tongue 150 is captively retained between the mounting plates 172 by a locking pin 174 received through apertures defined in the mounting plates 172 adjacent their respective lower ends.

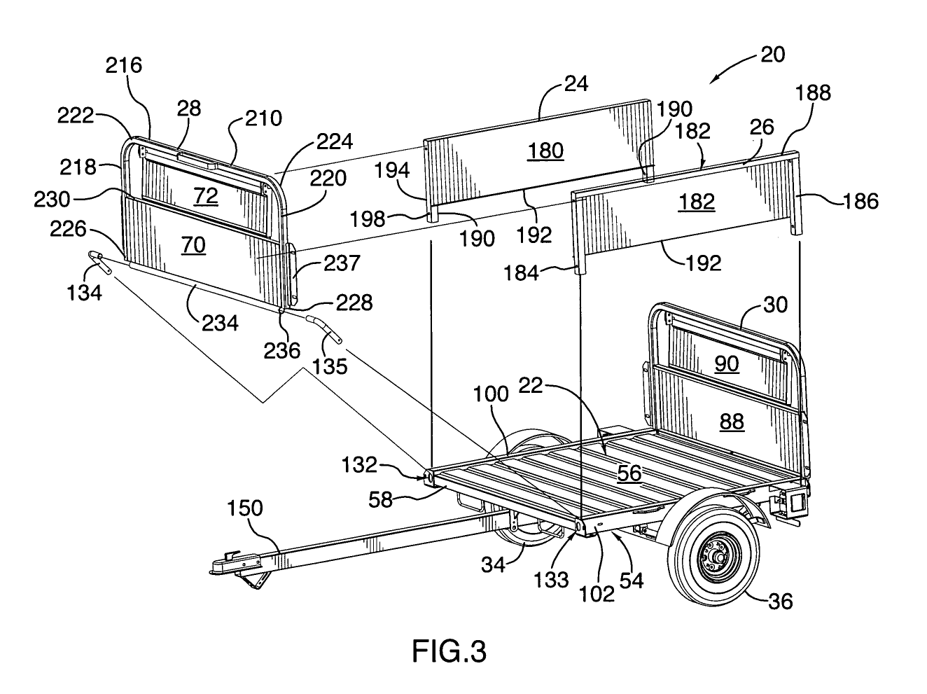

Referring to FIGS. 1 and 3, each of the side panels 24 and 26 includes a rectangular panel member 180 supported on an inverted U-shaped frame 182. While in this embodiment, the panel member 180 is fabricated from a sheet of steel, in other embodiments, the panel member could be made of expanded steel mesh. The frame 182 is built up of three frame members—two relatively short, spaced apart, vertically oriented, front and rear frame members 184 and 186 and a relatively long, horizontally oriented frame member 188. The long frame member 188 joins and is welded to the short, front and rear frame members 184 and 186. The free end portions 190 of each front and rear frame member 184, 186 extends beyond the lower margin 192 of the panel member 180 and are supported on angle members 110 disposed at the front and rear ends 106 and 108 of the longitudinal member 100, 102 (as the case may be). More specifically, each free end portion 190 sits on the first leg portion 112 of an angle member 110 with either its front face 194 or rear face 196 (as the case may be) abutting the second leg portion 114 of an angle member 110. An aperture 198 defined in the front face 194 or rear face 196 of the free end portion 190 is aligned with the aperture 122 formed in the second leg portion 114 of angle member 110. A fastener inserted into the aligned apertures 196 and 122 serves to tie each side panel 24, 26 to a respective longitudinal member 100, 102.

Referring to FIGS. 1, 3, 7 and 8, the structure of the front gate 28 is now described in greater detail. The front gate 28 includes an inverted U-shaped frame member 210; the first, generally rectangular, fixed gate panel member 70; and a second movable gate panel member 72. The panel members 70 and 72 are carried on the U-shaped frame member 210. The U-shaped frame member 210 is bent inwardly at two locations to define its U-shape profile. More specifically, the U-shaped frame member 210 includes a back portion 216 and two opposed, generally parallel, first and second arm portions 218 and 220, each joined to the back portion 216. The back portion 216 is disposed intermediate the first and second arm portions 218 and 220. The U-shaped frame member 210 is bent to form a first radiused corner portion 222 whereat the back portion 216 transitions to become the first arm portion 218, and a second radiused corner portion 224 whereat the back portion 216 transitions to become the second arm portion 220. The arm portions 218 and 220 extend generally perpendicularly away from the back portion 216.

The fixed gate panel member 70 is constructed sufficiently robust so as to be capable of bearing a load when the cargo bed 22 is deployed in its partially extended configurations 42, 50, 51 or 52, or fully extended configuration 53. In this embodiment, the fixed gate panel member 70 is a sheet of steel. In alternative embodiments, the fixed gate panel member could be made of expanded steel mesh. The fixed gate panel member 70 is carried between the first and second arm portions 218 and 220. More specifically, it extends from the terminal or free ends 226 and 228 of the first and second arm portions 218 and 220 toward the corner portions 222 and 224, but terminates roughly midway therebetween, such that there is a relatively large, gap G₁ (best shown in FIG. 7) defined between the first horizontal edge 230 of the fixed gate panel member 70 and the back portion 216. The gap G₁ is sized to accommodate the second movable gate panel member 72. Welded along the second horizontal edge 232 of the fixed gate panel member 70 is a tubular member 234. The tubular member 234 has a passageway 236 defined therein for receiving a portion of connector or hinge pins 134 and 135. As will be made clear below, the tubular member 234 functions as a hinge knuckle, and in cooperation with the hinge pins 134 and 135 permit the front gate 28 to be moved between its first, fully raised position 64 and its second, fully lowered position 66.

Projecting laterally outward from arm portion 216, 218 is a relatively narrow flange member 236, 237. The flange members 236 and 237 serve a dual purpose—first, they function as a stop preventing the rotation of the front gate 28 beyond the fully raised position 64 and second, they provide a connection site for releasably fastening the front gate 28 to the side panels 24 and 26. Each flange member 236, 237 has a pair of spaced apart, first and second apertures 238 and 240. Each aperture 238 is alignable with a eye bolt 242 attached to the front faces of the front frame members 184, so as to allow the eye bolt 242 to be received through the aperture 238. As best shown in FIG. 1, the front gate 28 is secured in the fully raised position 64 by a locking pin 244 inserted through the eye bolt 242.

While in this embodiment, the arrangement of eye bolts 242, locking pins 244 and flange members 236 and 237 is used to maintain the front gate 28 in the fully raised position 64, it should be appreciated that this need not be the case in every application. In alternative embodiments, other means for maintaining the front gate in the fully raised position could be used to similar advantage.

The second movable panel member 72 is hingedly connected to the back portion 216 of the U-shaped frame member 210. The movable panel member 72 includes a generally U-shaped frame 250 and a generally rectangular, steel panel 252 carried by the frame 250. The panel 252 is constructed sufficiently robust so to have at least some load bearing capacity when the cargo bed 22 is deployed in its partially extended configuration 42, 51 or fully extended configuration 53. In an alternative embodiment, the steel panel could be replaced with a steel expanded mesh or a configuration of spaced apart (horizontal and/or vertical) slats.

The U-shaped frame 250 has a pair of spaced apart, first and second arm portions 254 and 256 and a back portion 258 which joins the first arm portion 254 to the second arm portion 256. An angle iron 260 is used to form the back portion 258. The first leg 262 of the angle iron 260 is welded to an edge of the steel panel 252, while the second leg 264 of the angel iron 260 projects away from the steel panel 252 to form an abutment lip or flange 266. This flange 266 is configured to engage or abut a portion of the fixed panel member 70 adjacent the first horizontal edge 230 and operates as a stop preventing the second movable panel member 72 from moving beyond its lowered position 268. While in this embodiment, the abutment flange 266 is carried on the second movable gate panel member 72, it should be appreciated that this need not be the case in every application. In other embodiments, the abutment flange could be carried on or mounted to the fixed gate panel member 70 or even the U-shaped frame member 210. In still other embodiments, different means for arresting movement of the second gate panel member beyond its lowered position could be employed to similar advantage.

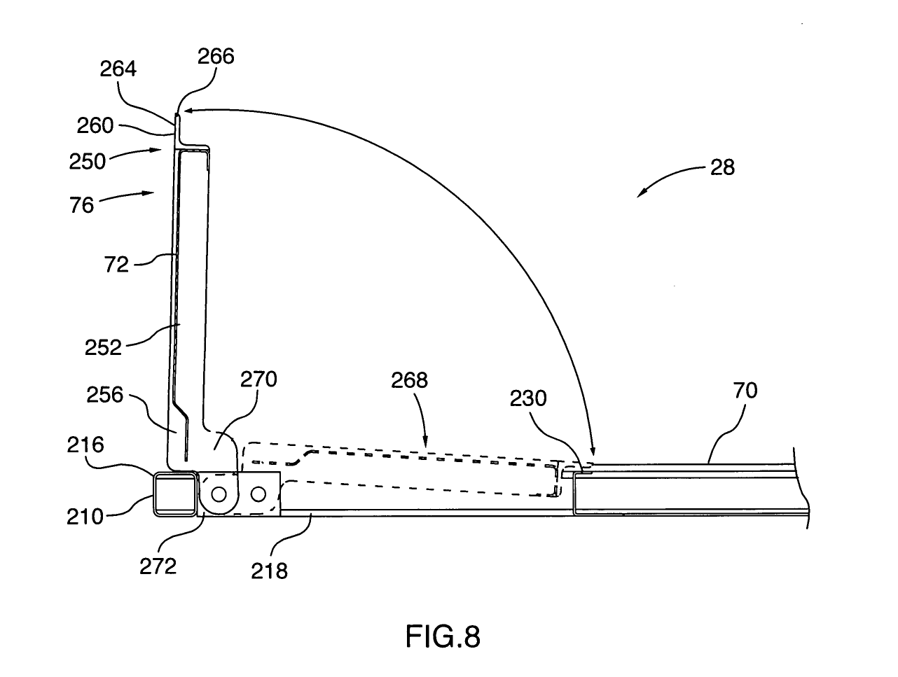

Each arm portion 254, 256 extends from one end of the flange 266 and terminates in a dog-legged portion 270. Each dog-legged portion 270 is hingedly connected to a tab 272 which depends from the back portion 216 of the U-shaped frame member 210. This arrangement permits the second movable gate panel portion 72 to pivot between a lowered position 274 and a raised (or upright) position 76, as best shown in FIG. 8.

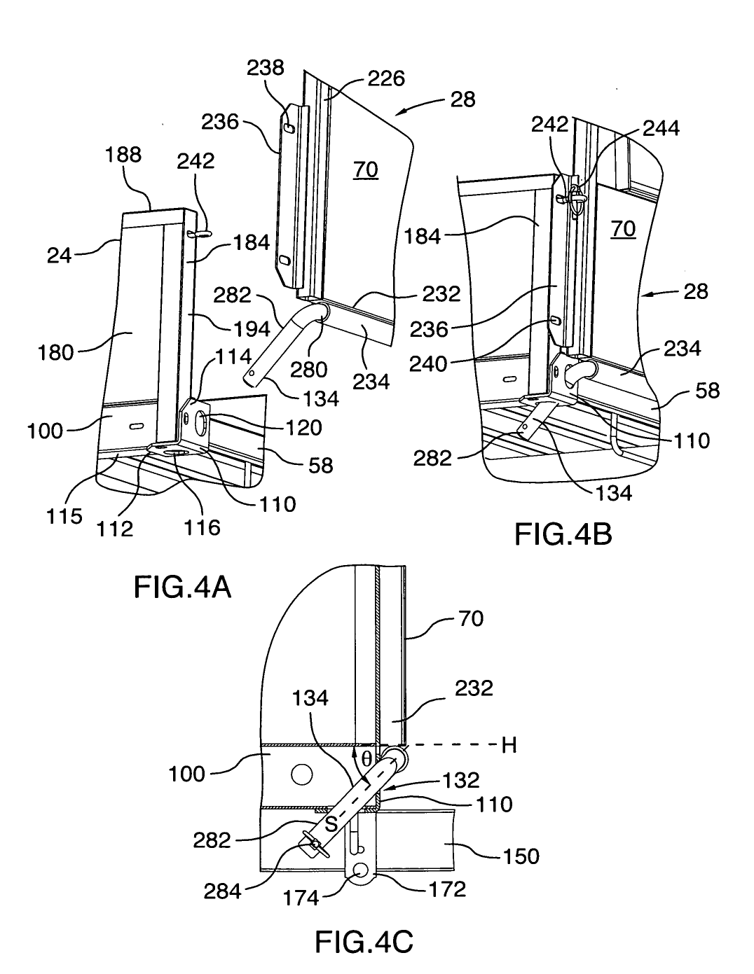

With specific reference to FIGS. 3, 4a, 4b and 4c, the front gate 28 is pivotally connected to support frame 54 via the hinge pins 134 and 135. In this embodiment, each hinge pin 134, 135 takes the form of a bent L-shaped rod having a first, relatively short leg portion 280 and a second, relatively long leg portion 282. The short leg portion 280 of each hinge pin 134, 135 is designed for insertion into one respective end of the tubular member 234 (see FIG. 4a). As best shown in FIGS. 4b and 4c, the long leg portion 282 of each hinge pin 134, 135 is configured to extend into one respective front socket 132, 133 (more specifically, through the bores 116 and 120 of one respective angle member 110 disposed at the front end 106 of the longitudinal member 100, 102 (as the case may be)). A locking pin 284 engageable within an aperture defined in the long leg portion 282 adjacent its terminal end, is provided to prevent each hinge pin 134, 135 from accidentally disengaging from its respective front socket 132, 133. In alternative embodiments, different locking means could also be employed.

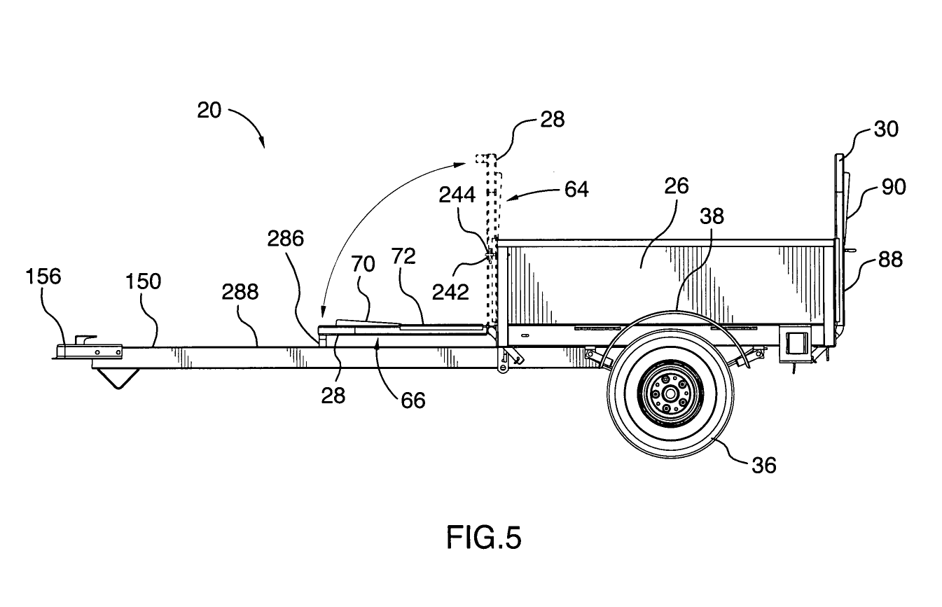

Having described the structure of the front gate 28, its operation will now be explained in greater detail with reference to FIGS. 1, 5, 6, 7 and 8. FIG. 1 shows the front gate 28 in its fully raised position 64. In that position, the fixed gate panel member 70 is substantially perpendicular to the cargo bed 22 (i.e. the plane defined by the fixed gate panel member 72 forms an angle of approximately 90 degrees with the horizontal plane H of the cargo bed 22). To move the front gate 28 from its fully raised position 64 to its fully lowered position 66, the locking pins 244 are disengaged from the eye bolts 242. With the locking pins 244 disengaged, the flange members 236 and 237 move unimpeded by the eye bolts 242 and the front gate 28 is pivoted downwardly toward the ground until it reaches its fully lowered position 66 (see FIGS. 5 and 6). In that position, a generally C-shaped handle 286 welded to the back portion 216 of the U-shaped frame member 210 comes to rest on the top face 288 of the tongue 150. The handle 286 performs a stop function, arresting further downward movement of the front gate 28. It will be appreciated that, in this embodiment, by virtue of the handle 286 abutting the tongue 150, the front gate 28 is at least partially supported by the tongue 150. When the front gate 28 is in the fully lowered position 66, the fixed gate panel member 70 is substantially flush with the cargo bed 22 (i.e. the plane defined by the fixed gate panel member 72 forms an angle of approximately 180 degrees with the horizontal plane H of the cargo bed 22) and the abutment flange 266 which projects from the second movable gate panel member 72 comes to bear against a portion of the fixed gate panel member 70.

The cargo bed 22 is deployed to its partially extended configuration 42 when the front gate 28 is its fully lowered position 66. In this embodiment, the cargo bed 22 measures approximately 48 in. in length (measured between the front and rear end portions 58 and 59 of floor panel 57) when in its most compact configuration 40, and approximately 72 in. in length (measured between from the rear end portion 59 and the outer edge of back portion 216 of the U-shaped frame member 210) In other embodiments, the cargo bed could be designed to have a greater or lesser length in its most compact configuration 40 and/or in its partially extended configuration 42.

To move the front gate 28 to its third position 68 (shown in FIG. 7) and deploy the cargo bed to its partially extended configuration 44, the movable gate panel member 72 is pivoted upwardly until the edges 290 of the dog-legged portions 270 come to bear against the back portion 216 of the U-shaped frame member 210 and the movable gate panel member 72 reaches the raised (or upright) position 76 (see FIG. 8). In this position, the movable gate panel member 72 forms a short wall which acts as a guard to prevent lading placed on the cargo bed 22 from sliding off.

Referring to FIGS. 3, 9, 11 and 13, the structure of the rear gate 30 is now described in greater detail. The rear gate 30 is generally similar to the front gate 28 in that it too includes an inverted U-shaped frame member 300; the first, generally rectangular, gate panel member 88; and the second gate panel portion 90. The panel members 88 and 90 are carried on the U-shaped frame member 300. The U-shaped frame member 300 resembles the U-shaped frame member 210 of the front gate 28. The frame member 300 is bent inwardly at two locations to define its U-shape profile. More specifically, the frame member 300 includes a back portion 302 and two opposed, generally parallel, first and second arm portions 304 and 306, each joined to the back portion 302. The back portion 302 is disposed intermediate the first and second arm portions 304 and 306. The frame member 300 is bent to form a first radiused corner portion 308 whereat the back portion 302 transitions to become the first arm portion 304, and a second radiused corner portion 310 whereat the back portion 302 transitions to become the second arm portion 306. The arm portions 304 and 306 extend generally perpendicularly away from the back portion 302.

The fixed gate panel member 88 is constructed sufficiently robust so as to be capable of bearing a load when the cargo bed 22 is deployed in its partially extended configurations 46, 50, 51 or 52 or fully extended configuration 53. In this embodiment, the fixed gate panel member 88 is a sheet of steel. In alternative embodiments, the fixed gate panel member could be made of expanded steel mesh. The fixed gate panel member 88 is carried between the first and second arm portions 304 and 306. More specifically, it extends from the terminal or free ends 312 and 314 of the first and second arm portions 304 and 306 toward the corner portions 308 and 310, but terminates roughly midway therebetween, such that there is a relatively large, gap G₂ (best shown in FIG. 7) defined between the first horizontal edge 320 of the fixed gate panel member 88 and the back portion 302. The gap G₂ is sized to accommodate the second movable gate panel member 90.

Contrary to the fixed gate panel member 70 of the front gate 28, the fixed gate panel member 88 of the rear gate 30 does not have a tubular member 234 welded along one of its horizontal edges. This is because, as will be made clear below, the rear gate 30 is not pivotally connected to the utility frame 54 and thus does require a hinge knuckle and hinge pin arrangement. Instead, the fixed gate panel member 70 is provided with a pair of first and second stake members 138 and 139. Stake member 138 is welded to the free end 312 of arm portion 304, while stake member 139 is welded to the free end 314 of arm portion 306. In this embodiment, each stake member 138, 139 has a first, relatively straight portion 322 and a bent portion 324 joined thereto and disposed at angle of approximately 45 degrees relative to the straight portion 322. The straight portion 322 of each stake member 138, 139 is almost entirely received in the hollow of arm portion 304, 306 and welded in place. Each straight portion 322 serves to securely fix the stake member 138, 139 to its respective arm portion 304, 206. As for each bent portion 324, it is configured for insertion into one of the rear sockets 136 and 137 defined by the angle members 110 and the rear ends 108 of longitudinal members 100 and 102, and allows attachment of the rear gate 30 to the support frame 54.

Projecting laterally outward from arm portion 304, 306 is a relatively narrow flange member 330, 332. These flange members 330 and 332 provide a connection site for securely fastening the rear gate 30 to the side panels 24 and 26. Each flange member 330, 332 has a pair of spaced apart, first and second apertures 334 and 336. Each aperture 334 is alignable with an eye bolt 338 attached to the rear faces of rear frame members 186, so as to allow the eye bolt 338 to be received through the aperture 334. As best shown in FIG. 5, the rear gate 30 is secured in the fully raised position 82 by a locking pin 340 inserted through the eye bolt 338.

The second movable panel member 90 configured generally similar to the movable panel 72 of the front gate 28. The movable panel member 90 is hingedly connected to the back portion 302 of the U-shaped frame member 300. The movable panel member 90 includes a generally U-shaped frame 350 and a generally rectangular, steel panel 352 carried by the frame 350. The panel 352 is constructed sufficiently robust so to have at least some load bearing capacity when the cargo bed 22 is deployed in its partially extended configuration 46 or 52, or fully extended configuration 53. In an alternative embodiment, the steel panel could be replaced with a steel expanded mesh or a configuration of spaced apart (horizontal and/or vertical) slats.

The U-shaped frame 350 has a pair of spaced apart, first and second arm portions 354 and 356 and a back portion 358 which joins the first arm portion 354 to the second arm portion 356. An angle iron 360 is used to form the back portion 358. The first leg 362 of the angle iron 360 is welded to an edge of the steel panel 352, while the second leg 364 of the angel iron 360 projects away from the steel panel 352 to form an abutment lip or flange 366. This flange 366 is configured to engage or abut a portion of the fixed panel member 90 adjacent the first horizontal edge 320 and operates as a stop preventing the second movable panel, member 90 from moving beyond its lowered position 368. While in this embodiment, the abutment flange 366 is carried on the second movable gate panel member 90, it should be appreciated that this need not be the case in every application. In other embodiments, the abutment flange could be carried on or mounted to the fixed gate panel member or even the U-shaped frame member 300. In still other embodiments, different means for arresting movement of the second gate panel member beyond its lowered position could be employed to similar advantage.

Each arm portion 354, 356 extends from one end of the flange 366 and terminates in a dog-legged portion 370. Each dog-legged portion 370 is hingedly connected to a tab 372 which depends from the back portion 302 of the U-shaped frame member 300. This arrangement permits the second movable gate panel portion 90 to pivot between a lowered position 374 and a raised (or upright) position 94, as best shown in FIG. 8.

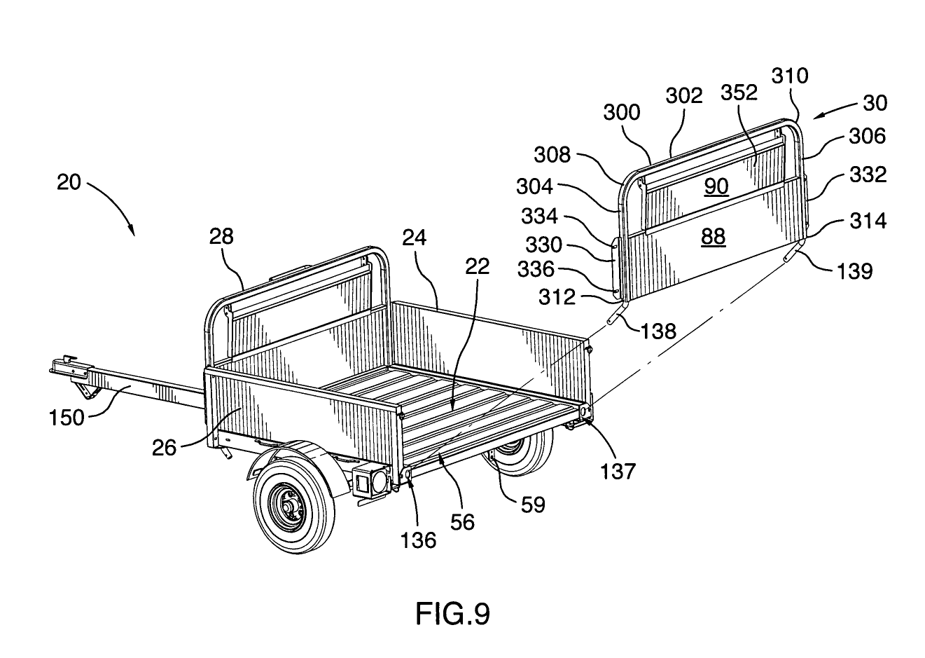

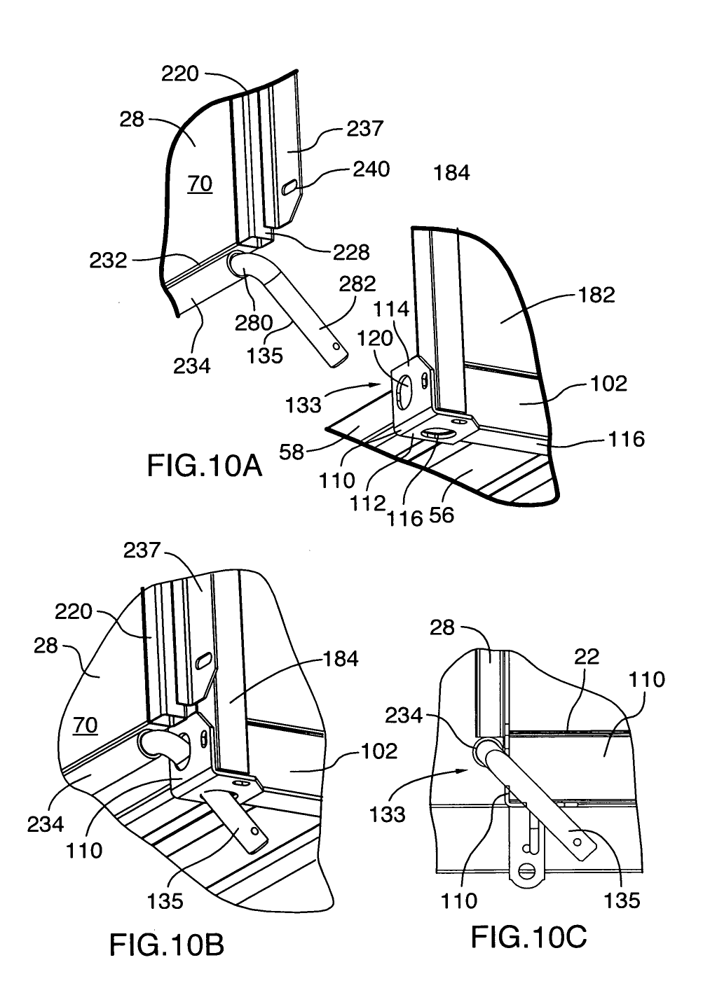

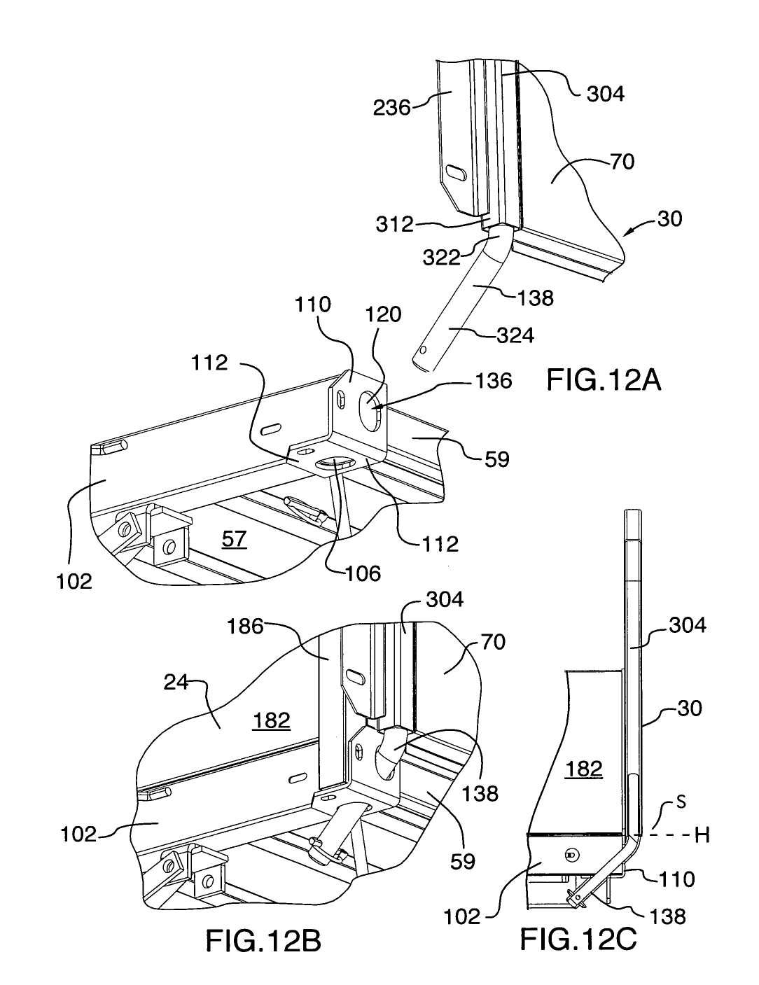

With specific reference to FIGS. 9, 10a, 10b, 10c, 11, 12a, 12b, and 12c, the rear gate 30 is releasably attached to support frame 54 via the stake member 138 and 139. When the rear gate 30 is in its fully raised position 82, the bent portion 324 of the stake member 138 is received in the rear socket 136, while the bent portion 324 of the stake member 139 is received within the rear socket 137 (see FIGS. 10a and 10c). However, this arrangement is reversed when the rear gate 30 is in its fully lowered position 84. In that case, the bent portion 324 of the stake member 138 is received in the rear socket 137, while the bent portion 324 of the stake member 139 is received within the rear socket 136 (see FIGS. 12a and 12c).

A locking pin 376 engageable within an aperture defined in the bent portion 324 adjacent its terminal end, is provided to prevent each stake member 138, 139 from accidentally disengaging from rear socket 136, 137 (as the case may be). In alternative embodiments, different locking means could be employed. While for reasons of safety, it is preferred that a utility trailer constructed in accordance with the principles of the present invention, in still other embodiments, a utility trailer could be configured without any such locking means. In such cases, gravity and a relatively close, sliding fit between the stake members and the sockets would help to prevent accidental disengagement of the stake members from the sockets.

A preferred configuration of the stake member-and-socket arrangement for the rear gate 30 has been described in the preceding paragraphs. However, it should be appreciated that, in alternative embodiments, the stake member-and-socket arrangement could be configured differently. For instance, the stake member-and-socket arrangement for the rear gate could be configured as described and shown in U.S. Pat. No. 6,378,893.

Having described the structure of the rear gate 30, its operation will now be explained in greater detail with reference to FIGS. 1, 11 and 13. FIG. 1 shows the rear gate 30 in its fully raised position 82. In that position, the fixed gate panel member 88 is substantially perpendicular to the cargo bed 22 (i.e. the plane defined by the fixed gate panel member 88 forms an angle of approximately 90 degrees with the horizontal plane H of the cargo bed 22). To deploy the rear gate 30 from its fully raised position 82 to its fully lowered position 84, the locking pins 376 are disengaged from the bent portions 324 so as to allow the stake members 138 and 139 to be removed from within the rear sockets 136 and 137, respectively. The rear gate 30 (now no longer connected to the support frame 54) is then flipped over (i.e. rotated 180 degrees). The stake member 138 is inserted into the rear socket 137 while the stake member 139 is inserted into the rear socket 136 (as shown in FIGS. 12a, 12b and 12c). With the rear gate 30 in its fully lowered position 84, the rear gate 30 is mounted to the support frame 54 in a cantilevered fashion. The fixed gate panel member 88 is substantially flush with the cargo bed 22 (i.e. the plane defined by the fixed gate panel member 88 forms an angle of approximately 180 degrees with the horizontal plane H of the cargo bed 22) and the abutment flange 366 which projects from the second movable gate panel member 80 comes to bear against a portion of the fixed gate panel member 88.

The cargo bed 22 is deployed to its partially extended configuration 46 when the rear gate 30 is its fully lowered position 84. In this embodiment, the cargo bed 22 measures approximately 6 ft. in length (measured between the front end portion 58 and the outer edge of back portion 302 of the U-shaped frame member 300) when in its partially extended configuration 44. In other embodiments, the cargo bed could be designed to have a greater or lesser length in its partially extended configuration 46.

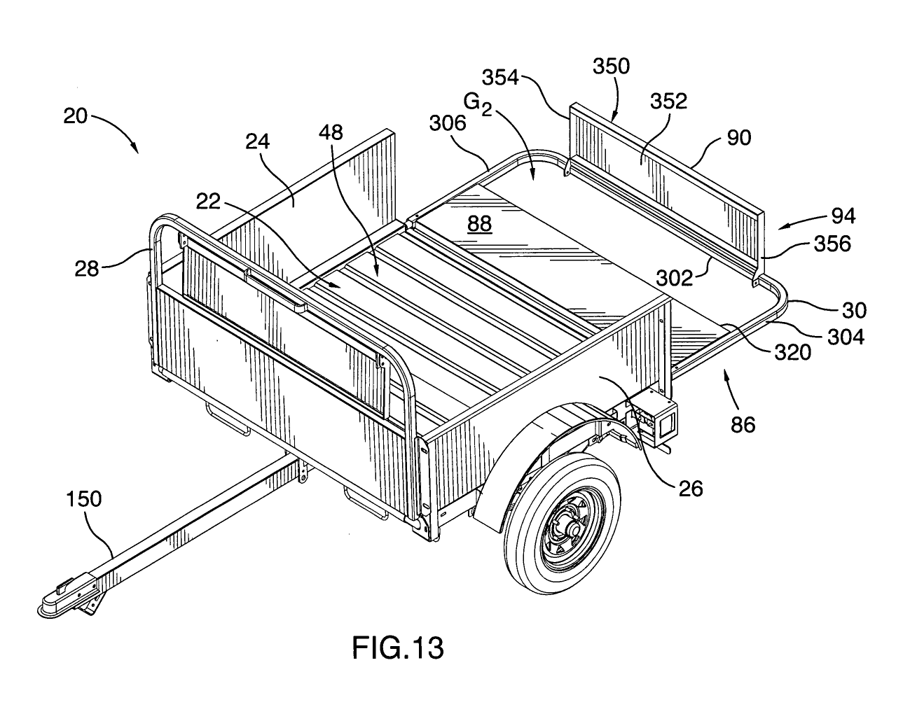

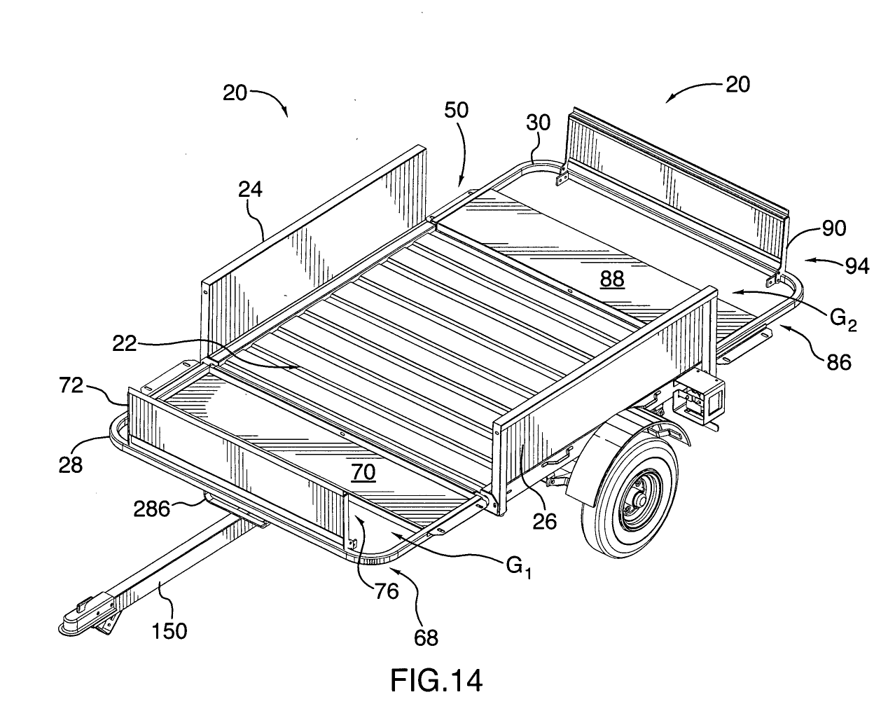

To move the rear gate 30 to its third position 86 (shown in FIG. 13) and deploy the cargo bed 22 to its partially extended configuration 48, the movable gate panel member 90 is pivoted upwardly until the edges 380 of the dog-legged portions 370 come to bear against the back portion 302 of the U-shaped frame member 300 and the movable gate panel member 90 reaches the raised (or upright) position 94. This is similar to the way the front gate 28 may be moved to its third position 68 as shown in FIG. 8. In the raised position 94, the movable gate panel member 90 forms a short wall which acts as a guard to prevent lading placed on the cargo bed 22 from sliding off.

FIG. 14 shows the cargo bed 22 deployed in its partially extended configuration 50. In this configuration, both the front and rear gates 28 and 30 are in their respective third positions 68 and 86 and the cargo bed 22 is extended to a length of approximately 75 in. (as measured from the first horizontal edge 230 of the fixed gate panel member 70 to the first horizontal edge 320 of the fixed gate panel member 88).

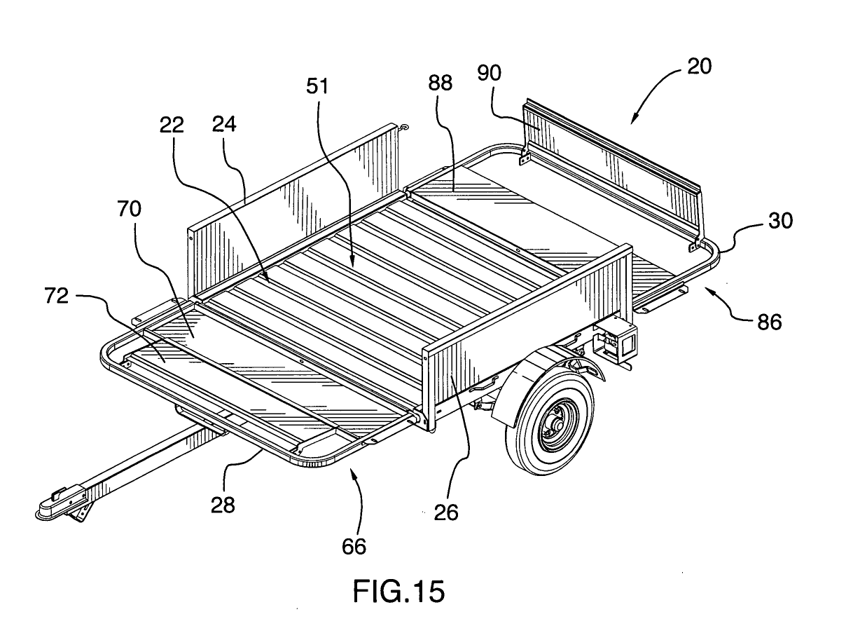

FIG. 15 shows the cargo bed 22 deployed in its partially extended configuration 51. In this configuration, the front gate 28 is in its fully lowered position 66 and the rear gate 30 is in its third position 86 and the cargo bed 22 is extended to a length of approximately 87.5 in. (as measured between the outer edge of back portion 216 of the U-shaped frame member 210 and the first horizontal edge 320 of the fixed gate panel member 88).

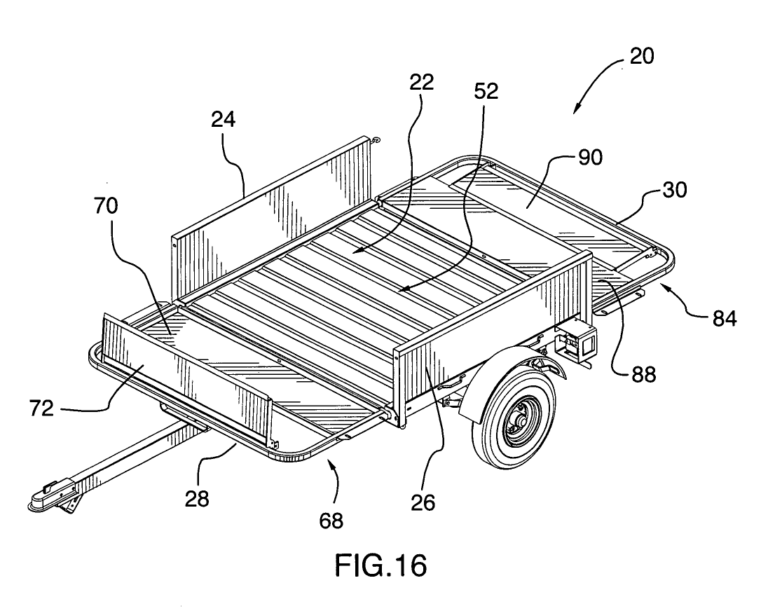

FIG. 16 shows the cargo bed 22 deployed in its partially extended configuration 52. In this configuration, it is the rear gate 30 that is in its fully lowered position 84 while the front gate is in its third position 68 and the cargo bed 22 is extended to a length of approximately 87.5 in. (as measured from the first horizontal edge 230 of the fixed gate panel member 70 to the outer edge of back portion 302 of the U-shaped frame member 300).

FIG. 17 shows the cargo bed 22 deployed in its fully extended configuration 53. In this configuration, both the front and rear gates 28 and 30 are in their respective fully lowered positions 66 and 84 and the cargo bed 22 is extended to a length of approximately 96 in. (as measured from the outer edge of back portion 216 of the U-shaped frame member 210 to the outer edge of back portion 302 of the U-shaped frame member 300).

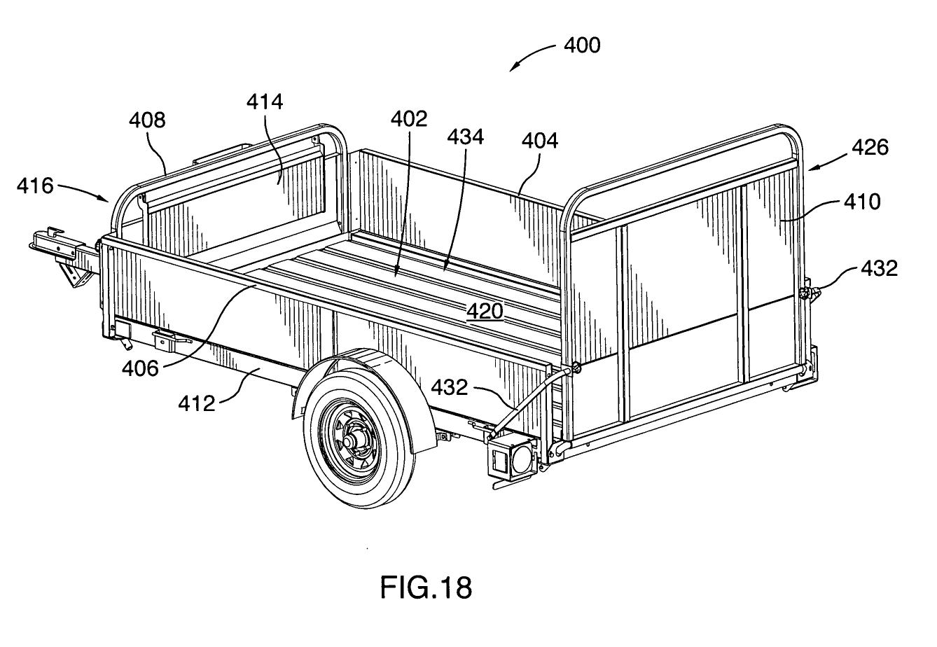

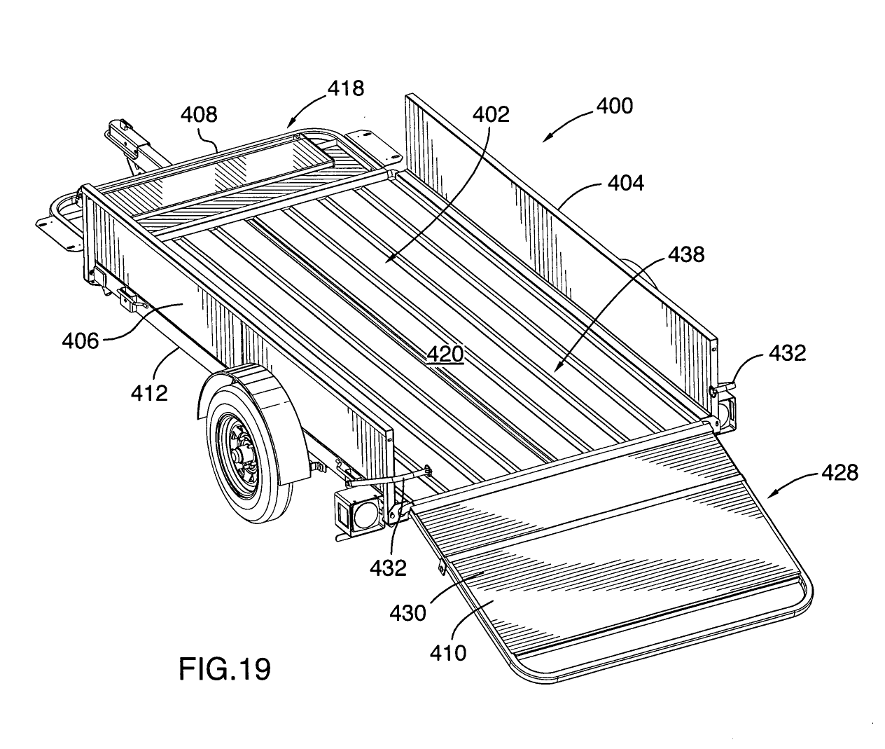

In the embodiment described and shown in FIGS. 1 to 17, the utility trailer was provided with a pivotable front gate and a removably attached rear gate. This need not be the case in very application. In alternative embodiments, a utility trailer constructed in accordance with the principles of the present invention could be configured to have the front gate removably attached to the support frame and the rear gate pivotally connected to the support frame. In other embodiments, both the front and rear gates could be either pivotally connected (see the embodiment shown in FIG. 18), or releasably attached, to the support frame. Further still, both front and rear gates could be configured with the plug-in-socket arrangement described and shown in U.S. Pat. No. 6,378,893. In still other embodiments, a utility trailer could be configured with a single door only (e.g. a rear door). Such a door could be either pivotally connected, or releasably attached, to the support frame.

Other changes are also possible. In the embodiment described and shown in FIGS. 1 to 17, both the front and rear gates have movable gate panel members which can be deployed to extend the cargo bed. In other embodiments, a utility trailer could be designed to have only a single movable gate panel member provided on either the front gate or the rear gate. An example of such an embodiment is shown in FIGS. 18, 19 and 20 wherein an alternate utility trailer is identified generally with reference numeral 400. The utility trailer 400 has a cargo bed 402 whose boundaries are defined by a pair of spaced apart side panels 404 and 406, and front and rear gates 408 and 410. The cargo bed 402 includes a support frame 412 and a floor 420 mounted atop the support frame 412. In this embodiment, both the front and rear gates 408 and 410 are pivotally connected to the support frame 412. But, only the front gate 408 is provided with a movable door panel member 414 generally similar in structure and operation to movable door panel member 72.

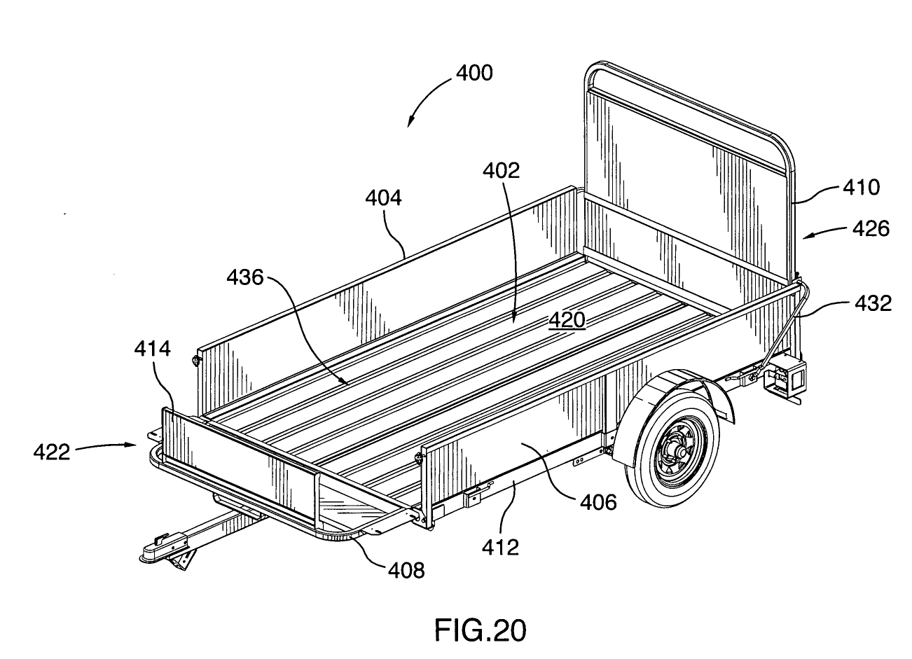

In like fashion to front gate 28, the front gate 408 is movable between a first, fully raised position 416 (shown in FIG. 18) and a second, fully lowered position 418 (shown in FIG. 19). When the front gate 408 is in the first, fully raised position 416, the gate 408 is in a substantially upright position relative to the floor 420 of the cargo bed 402 and access to the cargo bed 402 is at least partially restricted. When in the second, fully lowered position 418, the front gate 408 permits access to the cargo bed 402 to facilitate loading. The front gate 408 may also be moved to a third position 422 (shown in FIG. 20) whereat the movable gate panel member 414 is in a raised (or upright) position 424.

In this embodiment, the rear gate 410 is a landscape-type gate which can be deployed in a first raised (out-of-use) position 426 (shown in FIG. 18) and in a second, declined (in-use) position 428 (shown in FIG. 19). When in the first raised position 426, the rear gate 410 is in a substantially upright position relative to the floor 420 and access to the cargo bed 402 is at least partially restricted. Locking bars 432 mounted to the support frame 412 and engageable with the rear gate 410 are operable to maintain the rear gate 410 in the raised position 426. When in the second declined position 428, the rear gate 410 forms a ramp 430 which permits access to the cargo bed 402 and facilitates loading (in particular, loading of operator driven lawnmowers or the like).

In this embodiment, the cargo bed 402 can be configured to have a most compact configuration 434 (shown in FIG. 18), a partially extended configuration 436 (shown in FIG. 20) and a fully extended configuration 438 (shown in FIG. 19). When in its most compact configuration 434, the cargo bed 402 is defined by the support frame 412 and the floor 420 and measures approximately 92 in. in length. When in its partially extended configuration 436, a portion of the front gate 408 extends the length of the cargo bed 402, such that it measures approximately 109.75 in. in length. When in its fully extended configuration 438, the cargo bed 402 measures approximately 111 in. in length.

From the foregoing, it will be appreciated that the provision of movable gate panel members on the front and/or rear gates allows the cargo bed to be deployed in a plurality of configurations quickly and easily, and affords the user with greater freedom to configure the cargo bed to suit a particular application or specific cargo to be transported. As a result, a utility trailer constructed in accordance with the principles of the present invention tends to be very versatile. The manufacture of the movable gate panel member and its assembly to the front gate and/or rear gate tends not to be difficult and tends not to significantly add to the cost of the utility trailer. Moreover, the addition of a movable gate panel member does not significantly increase the overall weight of the utility trailer, such that the utility trailer may still remain relatively light-weight. Deployment of the movable gate panel member in the field tends to be simple and fast, and requires no additional hardware or tools.

In the embodiments illustrated in FIGS. 1 and 18, the cargo bed could be extended longitudinally (or lengthwise) by selectively deploying movable gate panel members on one or both of the front and rear gates of the utility trailer. In other embodiments, an alternate utility trailer could be provided with one or more gates in place of corresponding one or more side panels. In such embodiments, the cargo bed could be extended laterally (or widthwise) by deploying movable gate panel members on one or both these (side) gates.

While it is generally preferred for reasons of ease of deployment that the movable gate panel member be hingedly connected to portions of the gate, this need not be the case in every application. In other embodiments, one or both of the front and rear gates could be designed such that the second gate panel member can be deployed in its raised or lowered position by detaching it from its respective gate and reattaching it to the gate in the desired orientation (i.e. raised or lowered position).

While the foregoing discussion has focused on the application of the principles of the present invention to utility trailers, it should be appreciated that these principles could be applied to similar advantage to vehicles which incorporate cargo beds. For instance, in other embodiments, the rear of a pick-up truck, van or other like vehicle could be outfitted with a rear gate configured in accordance with the principles of the present invention, so that its cargo bed too could be extended by selective deployment of rear gate with a movable gate panel member.

Although the foregoing description and accompanying drawings relate to specific preferred embodiments of the present invention as presently contemplated by the inventor, it will be understood that various changes, modifications and adaptations, may be made without departing from the spirit of the invention.

What is claimed is:

1. An extendable cargo bed comprising:
a support frame;
a floor carried by the support frame, the floor defining at least partially the footprint of the cargo bed; and
a gate connected to one of the floor or the support frame; the gate including a first gate portion disposed adjacent the support frame and a second gate portion movable relative to the first gate portion;
the gate being deployable in first, second and third positions; when deployed in the first position, the gate extends upwardly from the floor;
when deployed in the second position, the gate is substantially flush with the floor and the footprint of the cargo bed is extended by the first and second gate portions;
when deployed in the third position, the first gate portion is substantially flush with the floor, the footprint of the cargo bed is extended by the first gate portion, and the second gate portion is oriented upwardly.

2. The extendable cargo bed of claim 1 wherein the gate is releasably attached to the support frame.

3. The extendable cargo bed of claim 2 wherein a portion of the gate slidingly engages a portion of the support frame to attach the gate to the support frame.

4. The extendable cargo bed of claim 1 wherein the gate is hingedly connected to the support frame.

5. The extendable cargo bed of claim 4 wherein the gate may be pivoted between the first and second positions.

6. The extendable cargo bed of claim 1 wherein:
the gate is a first gate; and
the extendable cargo bed has a second gate connected to one of the floor or the support frame.

7. The extendable cargo bed of claim 6 wherein:
the first bed is hingedly connected to the support frame; and
the second bed is releasably attached to the support frame.

8. The extendable cargo bed of claim 6 wherein:
the second gate includes a third gate portion disposed adjacent the support frame and a fourth gate portion movable relative to the third gate portion;
the second gate being deployable in fourth, fifth and sixth positions; when deployed in the fourth position, the second gate extends upwardly from the floor;
when deployed in the fifth position, the second gate is substantially flush with the floor and the footprint of the cargo bed is extended by the third and fourth gate portions;
when deployed in the sixth position, the third gate portion is substantially flush with the floor, the footprint of the cargo bed is extended by the third gate portion, and the fourth gate portion is oriented upwardly.

9. The extendable cargo bed of claim 8 wherein the footprint of the cargo bed is most compact when the first gate is deployed in the first position and the second gate is deployed in the fourth position.

10. The extendable cargo bed of claim 8 wherein the footprint of the cargo bed is fully extended when the first gate is deployed in the second position and the second gate is deployed in the fifth position.

11. The extendable cargo bed of claim 8 wherein the footprint of the cargo bed is at least partially extended when the first gate is deployed in one of the first position, the second position and the third position and the second gate is deployed in one of the fifth position and the sixth position.

12. The extendable cargo bed of claim 8 wherein the footprint of the cargo bed is at least partially extended when the second gate is deployed in one of the fourth position, the fifth position and the sixth position and the first gate is deployed in one of the second position and the third position.

13. The extendable cargo bed of claim 1 wherein:
the gate includes a frame having a back, and first and second spaced apart arms depending from the back; and
each of the first and second gate portions are mounted to the frame between the first and second arms.

14. The extendable cargo bed of claim 13 wherein the second gate portion is pivotally connected to the frame.

15. The extendable cargo bed of claim 13 wherein the second gate portion is pivotally connected to the first and second arms at locations adjacent the back.

16. The extendable cargo bed of claim 14 wherein:
the second gate portion is pivotable between fourth and fifth positions;
when in the fourth position, the second gate portion is oriented upwardly; and
when in the fifth position, the second gate portion has a substantially horizontal orientation.

17. The extendable cargo bed of claim 16 further comprising a first stop operable to prevent movement of the second gate portion beyond the fourth portion and a second stop operable to prevent movement of the second gate portion beyond the fifth position.

18. A utility trailer comprising:
an extendable cargo bed supported on wheels for rolling motion on the ground, the extendable cargo bed including:
a support frame;
a floor carried by the support frame, the floor defining at least partially the footprint of the cargo bed; and
a gate connected to one of the floor or the support frame; the gate including a first gate portion disposed adjacent the support frame and a second gate portion movable relative to the first gate portion;
the gate being deployable in first, second and third positions; when deployed in the first position, the gate extends upwardly from the floor;
when deployed in the second position, the gate is substantially flush with the floor and the footprint of the cargo bed is extended by the first and second gate portions;
when deployed in the third position, the first gate portion is substantially flush with the floor, the footprint of the cargo bed is extended by the first gate portion, and the second gate portion is oriented upwardly.

19. The extendable cargo bed of claim 17 wherein the gate is hingedly connected to the support frame.

20. The extendable cargo bed of claim 18 wherein the gate may be pivoted between the first and second positions.

21. The utility trailer of claim 17 wherein:
the support frame includes front and rear ends; and
the utility further includes a tow bar extending from the front end of the support frame;
when the gate is deployed in one of the second and the third positions, the gate is at least partially supported by the tow bar.
